(19) United States
(12) Patent Application Publication
(10) Pub. No.: US 2026/0040142 A1
(43) Pub. Date: Feb. 5, 2026

(54) RADIO COMMUNICATION SYSTEM, CONTROL APPARATUS, CONTROL METHOD, AND PROGRAM

(71) Applicant: NTT, Inc., Tokyo (JP)

(72) Inventors: Toshiro NAKAHIRA, Tokyo (JP); Daisuke MURAYAMA, Tokyo (JP); So TAKATANI, Tokyo (JP); Takatsune MORIYAMA, Tokyo (JP)

(73) Assignee: NTT, Inc., Tokyo (JP)

(21) Appl. No.: 18/997,006

(22) PCT Filed: Jul. 26, 2022
(86) PCT No.: PCT/JP2022/028794

§ 371 Date: Jan. 18, 2025

(51) Int. Cl. H04W 28/086

(52) U.S. Cl. CPC H04W 28/0862

(57) ABSTRACT

In order to suppress degradation of communication quality due to radio interference or the like, or occurrence of extra operating power consumption or the like of a wireless base station when the number of the wireless terminals in the wireless area is smaller than expected, a radio communication system includes a plurality of wireless base stations installed in a wireless area, and includes: a calculation unit configured to calculate an operating state pattern of the plurality of wireless base stations according to a state of a wireless terminal in the wireless area; an acquisition unit configured to acquire a state of the wireless terminal in the wireless area; and a control unit configured to control, on the basis of the operating state pattern, an operating state of the plurality of wireless base stations according to the state of the wireless terminal acquired by the acquisition unit.

### TECHNICAL FIELD

The present invention relates to a radio communication system, a control apparatus, a control method, and a program.

### BACKGROUND ART

For example, there is known a technology of arranging wireless base stations at a high density in order to increase the radio communication capacity in the space in an environment where many wireless terminals gather at a high density, such as a stadium, a lecture, or an event venue (see, for example, Non-Patent Literature 1).

### CITATION LIST

### Non-Patent Literature

Non-Patent Literature 1: Hideki Kawamata, “Trick of “High-density Wi-Fi” to be introduced to New National Stadium, about 1000 access points prepared”, [online] [Retrieved on Jun. 3, 1992], Internet <URL: https://xtech.nikkei.com/atcl/nxt/column/18/00933/091200007/?ST=nxt_thmdm_automotive>

### SUMMARY OF INVENTION

### Technical Problem

In a conventional technology, even when the number of wireless terminals changes during operation of a wireless area, an operating state of a wireless base station is constant. Therefore, when the number of wireless terminals is smaller than the expected maximum number of accommodated terminals, an excessive wireless base station enters an operation state, and thus, a problem such as deterioration in communication quality due to radio interference or the like or excessive operating power consumption of the wireless base station occurs.

An embodiment of the present invention has been made in view of the above problem, and suppresses degradation of communication quality due to radio interference or the like, or occurrence of extra operating power consumption or the like of a wireless base station when the number of wireless terminals in a wireless area is smaller than expected.

### Solution to Problem

In order to solve the above problem, a radio communication system according to an embodiment of the present invention is a radio communication system including a plurality of wireless base stations installed in a wireless area, and further including: a calculation unit configured to calculate an operating state pattern of the plurality of wireless base stations according to a state of a wireless terminal in the wireless area; an acquisition unit configured to acquire a state of the wireless terminal in the wireless area; and a control unit configured to control, on the basis of the operating state pattern, an operating state of the plurality of wireless base stations according to the state of the wireless terminal acquired by the acquisition unit.

### Advantageous Effects of Invention

According to an embodiment of the present invention, it is possible to suppress degradation of communication quality due to radio interference or the like, or occurrence of extra operating power consumption or the like of a wireless base station when the number of wireless terminals in a wireless area is smaller than expected.

### BRIEF DESCRIPTION OF DRAWINGS

FIG. 1 is a diagram illustrating a configuration example of a radio communication system according to the present embodiment.

FIG. 2 is a diagram for illustrating a problem and the outline of processing according to the present embodiment.

FIG. 3 is a flowchart illustrating an example of processing of a radio communication system according to Example 1.

FIG. 4 is a diagram illustrating an image of an example of an operating state pattern according to Example 1.

FIG. 5 is a diagram illustrating a configuration example of a radio communication system according to Example 2.

FIG. 6 is a flowchart illustrating an example of processing of the radio communication system according to Example 2.

FIG. 7 is a flowchart illustrating an example of processing of a radio communication system according to Example 3.

FIG. 8 is a diagram illustrating an example of a hardware configuration of a computer according to the present embodiment.

### DESCRIPTION OF EMBODIMENTS

An embodiment of the present invention (present embodiment) will be described below with reference to the drawings. The embodiment to be described below is merely an example, and embodiments to which the present invention is applied are not limited to the following embodiment.

### <Configuration Example of Radio Communication System>

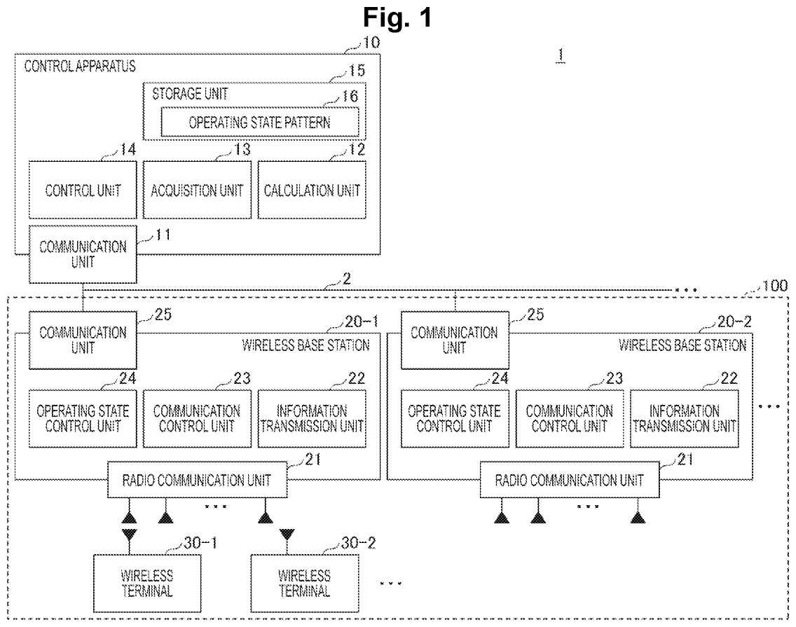

FIG. 1 is a diagram illustrating a configuration example of a radio communication system according to the present embodiment. A radio communication system 1 includes, for example, a plurality of wireless base stations 20-1, 20-2, . . . installed in a wireless area 100, and a control apparatus 10 that controls the plurality of wireless base stations 20-1, 20-2, In the following description, a “wireless base station 20” is used to indicate any one of wireless base stations 20-1, 20-2,

### (Configuration of Wireless Base Station)

The wireless base station 20 has a configuration of a computer, and implements, for example, a radio communication unit 21, an information transmission unit 22, a communication control unit 23, an operating state control unit 24, a communication unit 25, and the like by executing a predetermined program stored in a storage medium or the like by the computer. At least some of the functional configurations described above may be implemented by hardware.

Under the control of the communication control unit 23, the radio communication unit 21 performs radio communication processing of performing radio communication with a plurality of wireless terminals 30-1, 30-2, and the like by a predetermined radio communication scheme such as 5th Generation (5G) or long term evolution (LTE).

The information transmission unit 22 performs information transmission processing of transmitting information indicating the state of the wireless terminals, such as the number of wireless terminals 30 connected to its own station (wireless base station 20), to the control apparatus 10 via the communication unit 25.

The communication control unit 23 performs communication control processing of controlling the radio communication unit 21 to perform radio communication with the wireless terminal 30 in the coverage area of its own station among the plurality of wireless terminals 30-1, 30-2, . . . in the wireless area 100.

The operating state control unit 24 performs operating state control processing of setting the wireless base station 20 to the “operating state” in which radio communication with the wireless terminal 30 is performed, or to the “non-operating state” in which power consumption is lower than that in the “operating state” and radio communication with the wireless terminal 30 is not performed, according to the control from the control apparatus 10. Here, the non-operating state may be, for example, a state in which the wireless base station 20 is set to the sleep state, a state in which transmission of radio waves by the radio communication unit 21 is stopped, or the like. In the non-operating state, as long as the power consumption is lower than that in the operating state and the radio communication with the wireless terminal 30 is not performed, an implementation method thereof may be any method.

The communication unit 25 connects the wireless base station 20 to the communication network 2, and performs transmission processing of transmitting and receiving various control information to and from the control apparatus 10, for example.

### (Configuration of Control Apparatus)

The control apparatus 10 is, for example, an information processing device including a configuration of a computer or a system including a plurality of computers. The control apparatus 10 is a computer included in the control apparatus 10 and executes a predetermined program stored in a storage medium or the like to implement the communication unit 11, the calculation unit 12, the acquisition unit 13, the control unit 14, the storage unit 15, and the like. At least some of the functional configurations described above may be implemented by hardware.

The communication unit 11 connects the control apparatus 10 to the communication network 2 and performs communication processing of communicating with a plurality of wireless base stations 20-1, 20-2, . . . , a calculation device 500 described later, or the like.

The calculation unit 12 performs calculation processing of calculating the operating state pattern of the plurality of wireless base stations 20-1, 20-2, . . . according to the number of wireless terminals 30 in the wireless area 100. For example, the calculation unit 12 calculates an operating state pattern indicating whether to operate each of the plurality of wireless base stations 20-1, 20-2, . . . according to the number of wireless terminals 30 in the wireless area 100.

Preferably, the calculation unit 12 calculates an operating state pattern that corresponds to the number of wireless terminals 30 in the wireless area 100, can accommodate the wireless terminals 30, and minimizes the number of wireless base stations 20 to be operated.

The acquisition unit 13 performs acquisition processing of acquiring the number of wireless terminals in the wireless area 100. For example, the acquisition unit 13 collects the number of wireless terminals 30 connected to the wireless base station 20 from each of the plurality of wireless base stations 20-1, 20-2, . . . , and calculates the number of wireless terminals in the wireless area 100 by summing up the collected number of wireless terminals 30.

The control unit 14 performs control processing of controlling the operating state of the plurality of wireless base stations 20-1, 20-2, . . . according to the number of wireless terminals 30 in the wireless area 100 acquired by the acquisition unit 13 on the basis of the operating state pattern.

The storage unit 15 is implemented by, for example, a program executed by a computer included in the control apparatus 10, a storage device included in the computer, and the like, and performs storage processing of storing the operating state pattern 16 and the like calculated by the calculation unit 12.

### (Problem and Outline of Processing)

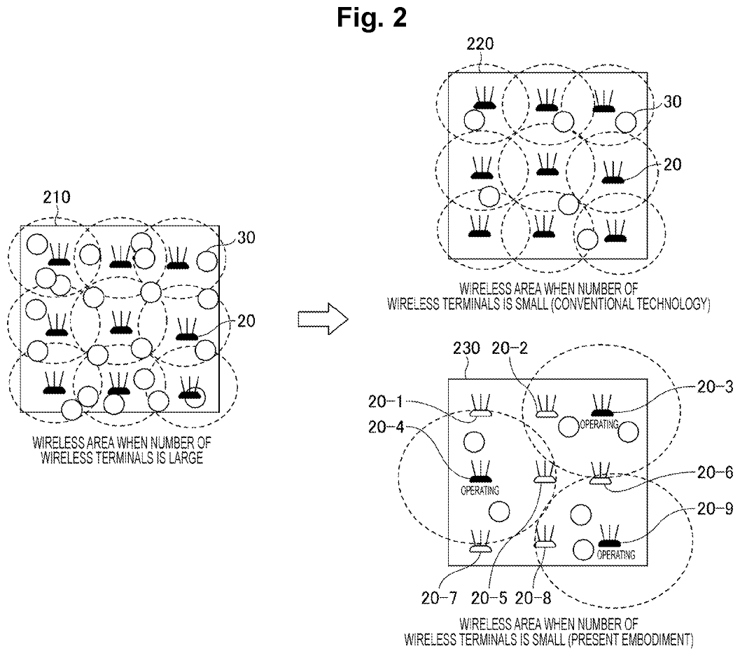

FIG. 2 is a diagram for illustrating a problem and the outline of processing according to the present embodiment. In a wireless area 210 in a case where the number of wireless terminals is large in FIG. 2, a plurality of wireless base stations 20 are installed so that the plurality of wireless terminals 30 can perform radio communication with a predetermined communication quality (for example, throughput or the like).

In the conventional technology, as illustrated in a (conventional) wireless area 220 in a case where the number of wireless terminals is small in FIG. 2, even when the number of wireless terminals 30 in the wireless area 220 becomes small, the operating states of the plurality of wireless base stations 20 are constant. Therefore, in the conventional technology, when the number of wireless terminals 30 is smaller than the expected maximum number of accommodated terminals, an excessive wireless base station 20 enters an operation state, and thus, a problem such as deterioration in communication quality due to radio interference or the like or excessive operating power consumption of the wireless base station 20 occurs.

Therefore, the control apparatus 10 dynamically controls the operating situations of the plurality of wireless base stations 20 according to the number of wireless terminals 30, on the basis of the operating state pattern 16 storing the operating situations of the plurality of wireless base stations 20-1 to 20-9 according to the number of wireless terminals 30 in the wireless area 230. For example, when the number of wireless terminals 30 is six, the operating state pattern 16 stores that the wireless base stations 20-3, 20-4, 20-9 are set to the operating state and the other wireless base stations 20-1, 20-2, and 20-5 to 20-8 are set to the non-operating state. As a result, the control apparatus 10 controls only the wireless base stations 20-3, 20-4, 20-9, among the plurality of wireless base stations 20-1 to 20-9, to be in the operating state like the wireless area (the present embodiment) 230 in a case where the number of wireless terminals is small in FIG. 2. In FIG. 2, the white wireless base stations 20 indicate that the wireless base stations 20 are not in operation.

As a result, according to the radio communication system 1 according to the present embodiment, it is possible to suppress degradation of communication quality due to radio interference or the like, or occurrence of extra operating power consumption or the like of a wireless base station 20 when the number of wireless terminals 30 in a wireless area 230 is smaller than expected.

### <Flow of Processing>

Next, a flow of a control method of the radio communication system 1 according to the present embodiment will be described with a plurality of embodiments.

### Example 1

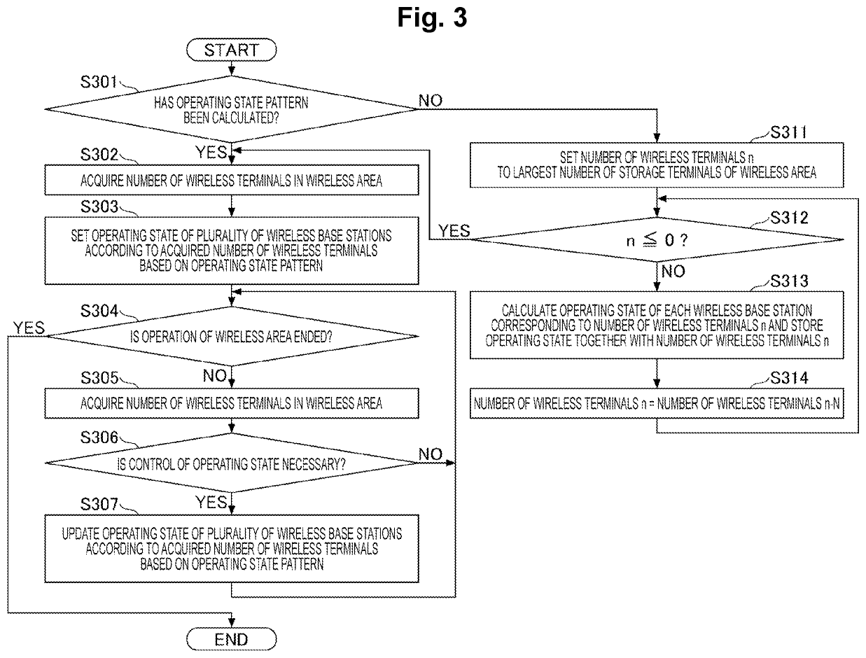

FIG. 3 is a flowchart illustrating an example of processing of the radio communication system 1 according to Example 1. This processing is an example of processing performed by the radio communication system 1 when the wireless area 100 is operated in the radio communication system 1 as illustrated in FIG. 1.

In step S301, for example, when starting the operation of the wireless area 100, the calculation unit 12 determines whether the operating state pattern 16 has been calculated. For example, when the valid operating state pattern 16 is stored in the storage unit 15, the calculation unit 12 determines that the operating state pattern 16 has been calculated. When the operating state pattern 16 has been calculated, the calculation unit 12 shifts the process to step S302. On the other hand, when the operating state pattern 16 has not been calculated, the calculation unit 12 performs the processing of steps S311 to S314 (hereinafter, referred to as calculation processing of the operating state pattern).

When the process proceeds to step S311, the calculation unit 12 sets the number n of wireless terminals to the maximum number of accommodated terminals in the wireless area 100. Here, the maximum number of accommodated terminals is a design value (design condition) indicating a maximum value of the number of wireless terminals 30 that can be accommodated in the wireless area 100. The maximum number of accommodated terminals is stored in advance in the storage unit 15 or the like by, for example, an administrator, a designer, or the like.

In step S312, the calculation unit 12 determines whether the number n of wireless terminals is 0 or less. When the number n of wireless terminals is not 0 or less, the calculation unit 12 shifts the process to step S313. On the other hand, when the number n of wireless terminals is 0 or less, the calculation unit 12 ends the calculation processing of the operating state pattern 16 and shifts the processing to step S302.

When the process proceeds to step S313, the calculation unit 12 calculates the operating state of each wireless base station 20 corresponding to the number n of wireless terminals, and stores the calculated operating state of each wireless base station 20 together with the number n of wireless terminals in the operating state pattern 16.

The operating state of each wireless base station 20 can be calculated, for example, by setting the position of the wireless base station 20 installed in the wireless area 100 as a candidate for the installation position of the wireless base station 20 and applying a known station designing technique of the wireless base station. For example, the calculation unit 12 sets the wireless base station 20 at the installation position of the wireless base station 20 calculated by a known placement station design technology as “operating”, and sets the other wireless base stations 20 as “not operating”.

As a specific example, the calculation unit 12 calculates a necessary communication band in the wireless area 100 from the number n of wireless terminals. In addition, the calculation unit 12 obtains the number of wireless base stations 20 for obtaining a necessary communication band in the wireless area 100. Furthermore, the calculation unit 12 determines the wireless base station 20 to be set to the operating state so that the obtained number of wireless base stations 20 can cover the entire wireless area 230.

In step S314, the calculation unit 12 subtracts calculation step N (N is an integer of 1 or more) from the number n of wireless terminals, and returns the process to step S312.

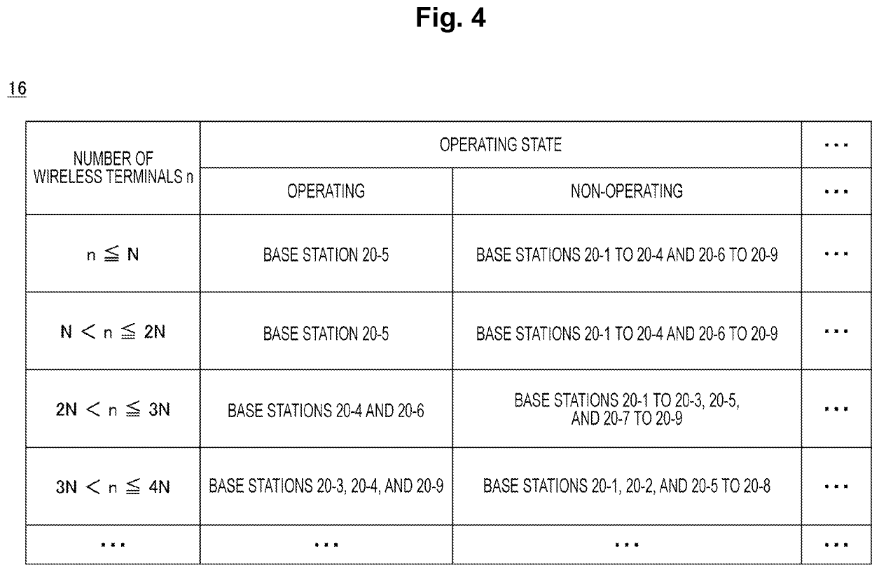

By the processing in steps S311 to S314, the calculation unit 12 can calculate the operating state pattern 16 as illustrated in FIG. 4, for example.

FIG. 4 is a diagram illustrating an image of an example of an operating state pattern according to Example 1. In the example of FIG. 4, the operating state pattern 16 stores the operating states (operating or non-operating) of the plurality of wireless base stations 20-1 to 20-9 corresponding to the number n of wireless terminals. For example, the operating state pattern 16 illustrated in FIG. 4 indicates that when the number n of wireless terminals is 2N or less, only the wireless base station 20-5 is operated, and the other wireless base stations 20-1 to 20-4 and 20-6 to 20-9 are set to non-operating (not operated). In addition, the operating state pattern 16 illustrated in FIG. 4 indicates that when the number n of wireless terminals is larger than 2N and 3N or less, the wireless base stations 20-4 and 20-6 are operated, and the other wireless base stations 20-1 to 20-3, 20-5, and 20-7 to 20-9 are set to non-operating.

The operating state pattern 16 illustrated in FIG. 4 is an example. For example, the operating state pattern 16 may store only information on the wireless base station 20 to be operated or information on the wireless base station 20 not to be operated (set to non-operating) according to the number n of wireless terminals. In this case, for example, the control apparatus 10 can specify whether to operate each of the plurality of wireless base stations 20-1 to 20-9 by using the information on the plurality of wireless base stations 20 in the wireless area 100 and the operating state pattern 16.

Here, referring back to FIG. 3, the description of the flowchart will be continued. When the process proceeds to step S302, the acquisition unit 13 acquires the number of wireless terminals 30 in the wireless area 100. For example, the acquisition unit 13 collects the number of wireless terminals 30 connected to their own station (wireless base station 20) from each wireless base station 20, and obtains the number of wireless terminals 30 in the wireless area 100 by summing up the collected number of wireless terminals 30.

In step S303, the control unit 14 sets the operating states of the plurality of wireless base stations 20-1, 20-2, . . . according to the number of wireless terminals 30 acquired by the acquisition unit 13 on the basis of the operating state pattern 16 stored in the storage unit 15. For example, the control unit 14 acquires the operating states (operating or non-operating) of the plurality of wireless base stations 20-1, 20-2, . . . corresponding to the number of wireless terminals 30 acquired by the acquisition unit 13 from the operating state pattern 16 as illustrated in FIG. 4. In addition, the control unit 14 transmits an operating state change instruction to the wireless base stations 20 that needs to change the operating state according to the acquired operating states of the plurality of wireless base stations 20-1, 20-2,

The operating state control unit 24 of a wireless base station 20 that has received the operating state change instruction sets the operating state of its own station (wireless base station 20) to operating or non-operating, according to the operating state change instruction received from the control apparatus 10.

In step S304, the control apparatus 10 determines whether to end the operation of the wireless area 100. For example, the control apparatus 10 determines to end the operation of the wireless area 100 when a preset end date and time of the wireless area 100 is reached, when an end instruction of the wireless area 100 is received from an external device or the like, or the like.

When the operation of the wireless area 100 is not ended, the control apparatus 10 shifts the process to step S305. On the other hand, when ending the operation of the wireless area 100, the control apparatus 10 ends the processing of FIG. 3. In this case, the control apparatus 10 may set the plurality of wireless base stations 20 to the “non-operating” state as necessary.

When the process proceeds to step S305, the acquisition unit 13 acquires the number of wireless terminals 30 in the wireless area 100. This processing may be similar to the processing in step S302.

In step S306, the control unit 14 determines whether it is necessary to control the operating state of the plurality of wireless base stations 20. For example, when the number of wireless terminals 30 in the wireless area 100 is within a preset range in which control of the operating state is unnecessary, the control unit 14 determines that control of the operating state is unnecessary. On the other hand, when the number of wireless terminals 30 in the wireless area 100 is not within a preset range in which control of the operating state is unnecessary, the control unit 14 determines that control of the operating state is necessary. When it is necessary to control the operating state, the control unit 14 shifts the process to step S307. On the other hand, when it is not necessary to control the operating state, the control unit 14 returns the process to step S304.

After the processing is shifted to step S307, the control unit 14 updates the operating state of the plurality of wireless base stations 20-1, 20-2, . . . according to the number of wireless terminals 30 acquired by the acquisition unit 13 on the basis of the operating state pattern 16 stored in the storage unit 15. For example, as similar to the processing of step S303, the control unit 14 transmits an operating state change instruction to the wireless base station 20 that needs to change the operating state. After executing the processing of step S307, the control unit 14 returns the process to step S304.

As a result of the processing of FIG. 3, the acquisition unit 13 periodically acquires the number of wireless terminals 30 in the wireless area 100. Furthermore, the control unit 14 dynamically controls the operating state of the plurality of wireless base stations 20-1, 20-2, . . . according to the number of wireless terminals 30 in the wireless area 100 acquired by the acquisition unit 13, on the basis of the operating state pattern 16.

### Example 2

In Example 1, an example in which the control apparatus 10 includes the calculation unit 12 that calculates the operating state pattern 16 has been described. However, this is an example, and the control apparatus 10 may store the operating state pattern 16 calculated by another information processing device in the storage unit 15 in advance.

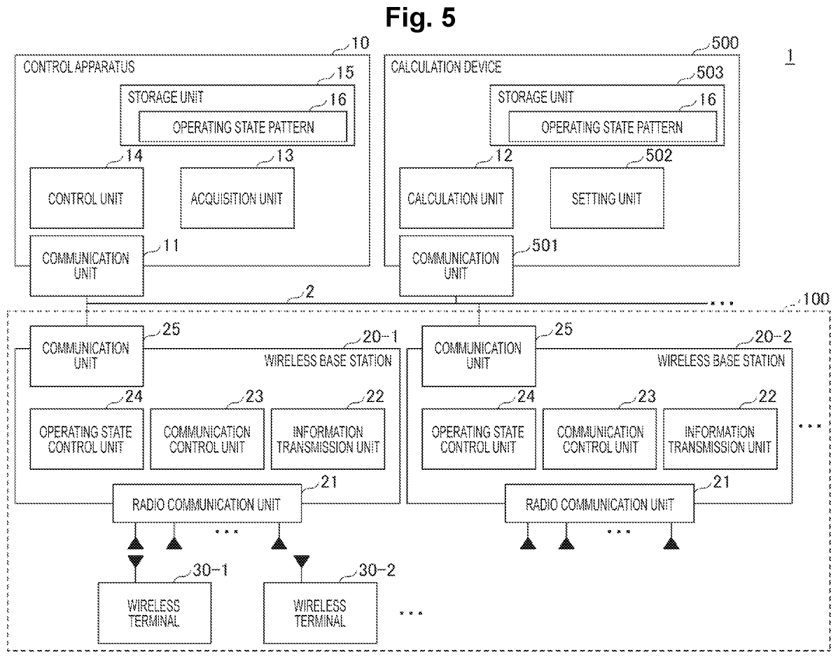

FIG. 5 is a diagram illustrating a configuration example of a radio communication system according to Example 2. In the example of FIG. 5, the radio communication system 1 according to Example 2 includes a calculation device 500 in addition to the system configuration of the radio communication system 1 described in FIG. 1.

The calculation device 500 is an information processing device having a configuration of a computer or a system including a plurality of computers. The calculation device 500 executes a predetermined program stored in a storage medium or the like to implement a communication unit 501, the calculation unit 12, a setting unit 502, a storage unit 503, and the like. At least some of the functional configurations described above may be implemented by hardware.

The communication unit 501 connects the calculation device 500 to the communication network 2 and performs communication processing of communicating with the control apparatus 10.

The calculation unit 12 corresponds to the calculation unit 12 included in the control apparatus 10 described with reference to FIG. 1. As similar to Example 1, the calculation unit 12 performs calculation processing of calculating the operating state patterns 16 of the plurality of wireless base stations 20-1, 20-2, . . . . In Example 2, the control apparatus 10 need not include the calculation unit 12.

The setting unit 502 performs setting processing of setting the operating state pattern 16 calculated by the calculation unit 12 in the control apparatus 10. The operating state pattern 16 set in the control apparatus 10 by the setting unit 502 is stored in the storage unit 15 of the control apparatus 10.

The storage unit 503 is implemented by, for example, a program executed by a computer included in the calculation device 500, a storage device included in the computer, and the like, and performs storage processing of storing the operating state pattern 16 and the like calculated by the calculation unit 12.

Note that the system configuration of the radio communication system 1 according to Example 2 illustrated in FIG. 5 is an example. For example, at least a part of the communication unit 501, the calculation unit 12, the setting unit 502, and the storage unit 503 may be implemented by a program executed by a virtual machine or the like on a cloud.

### <Flow of Processing>

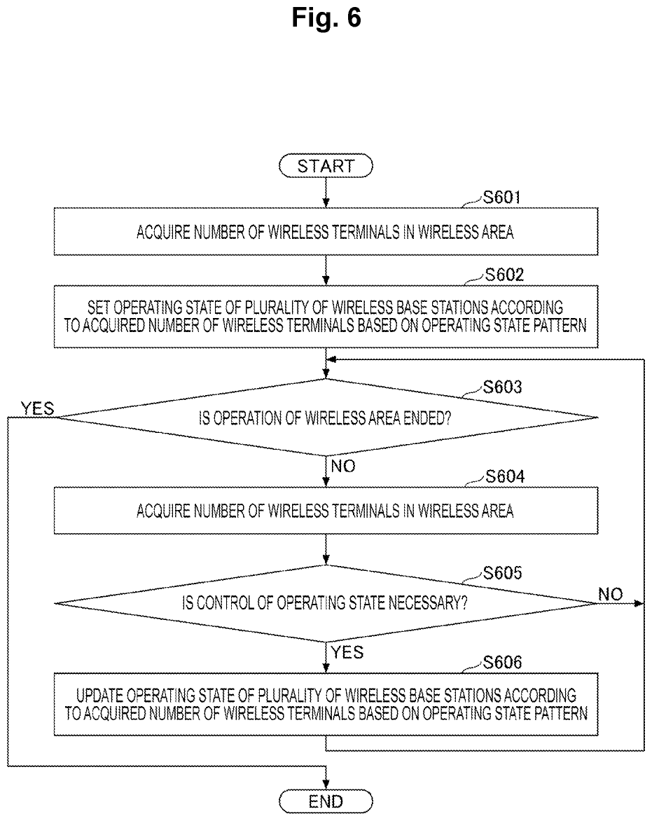

FIG. 6 illustrates an example of processing of the radio communication system according to Example 2. This processing is an example of processing performed by the radio communication system 1 when the wireless area 100 is operated in the radio communication system 1 as illustrated in FIG. 5. The processing in steps S601 to S606 in FIG. 6 is similar to the processing in steps S302 to S307 described in FIG. 3, and thus detailed description of similar processing contents is omitted here.

In step S601, for example, when starting the operation of the wireless area 100, the acquisition unit 13 acquires the number of wireless terminals 30 in the wireless area 100.

In step S602, the control unit 14 sets the operating state of the plurality of wireless base stations 20-1, 20-2, . . . according to the number of wireless terminals 30 acquired by the acquisition unit 13, on the basis of the operating state pattern 16 stored in advance in the storage unit 15.

In step S603, the control apparatus 10 determines whether to end the operation of the wireless area 100. When the operation of the wireless area 100 is not ended, the control apparatus 10 shifts the process to step S604. On the other hand, when ending the operation of the wireless area 100, the control apparatus 10 ends the processing of FIG. 6.

When the process proceeds to step S604, the acquisition unit 13 acquires the number of wireless terminals 30 in the wireless area 100.

In step S605, the control unit 14 determines whether it is necessary to control the operating state of the plurality of wireless base stations 20. When it is necessary to control the operating state, the control unit 14 shifts the process to step S606. On the other hand, when it is not necessary to control the operating state, the control unit 14 returns the process to step S603.

After the processing is shifted to step S606, the control unit 14 updates the operating state of the plurality of wireless base stations 20-1, 20-2, . . . according to the number of wireless terminals 30 acquired by the acquisition unit 13, on the basis of the operating state pattern 16 stored in the storage unit 15. After executing the processing of step S606, the control unit 14 returns the process to step S603.

As a result of the processing of FIG. 6, as similar to Example 1, the control apparatus 10 can dynamically control the operating state of the plurality of wireless base stations 20-1, 20-2, . . . according to the number of wireless terminals 30 in the wireless area 100.

### Example 3

In Examples 1 and 2, the control apparatus 10 controls the operating state of the plurality of wireless base stations 20-1, 20-2, . . . according to the number of wireless terminals 30 in the wireless area 100. However, the present invention is not limited thereto, and the control apparatus 10 may dynamically control the operating state of the plurality of wireless base stations 20-1, 20-2, . . . according to, for example, the communication traffic amount of the wireless terminal 30 in the wireless area 100.

In this case, instead of the operating state patterns 16 of the plurality of wireless base stations 20 according to the number n of wireless terminals as illustrated in FIG. 4, the control apparatus 10 stores in advance the operating state patterns 16 of the plurality of wireless base stations 20 according to the communication traffic amount of the wireless terminals 30, in the storage unit 15.

Instead of the operating state patterns 16 of the plurality of wireless base stations 20 according to the number n of wireless terminals, the calculation unit 12 calculates the operating state patterns 16 of the plurality of wireless base stations 20 according to the communication traffic amount of the wireless terminals 30.

For example, the calculation unit 12 calculates a necessary communication band in the wireless area 100 from the communication traffic amount of the wireless terminals 30. In addition, the calculation unit 12 obtains the number of wireless base stations 20 for obtaining a necessary communication band in the wireless area 100. Furthermore, the calculation unit 12 determines the wireless base stations 20 to be set to the operating state so that the obtained number of wireless base stations 20 can cover the entire wireless area 230. By performing this processing for each communication traffic amount of the wireless terminals 30, the calculation unit 12 can calculate the operating state patterns 16 of the plurality of wireless base stations 20 according to the communication traffic amount of the wireless terminals 30. However, the method of calculating the operating state patterns 16 of the plurality of wireless base stations 20 according to the communication traffic amount of the wireless terminals 30 is not limited thereto.

### <Flow of Processing>

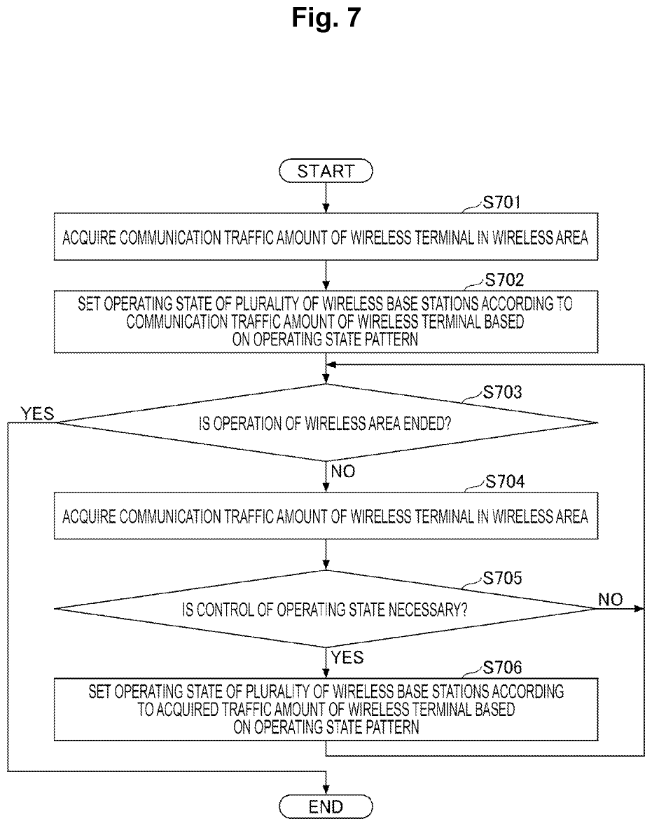

FIG. 7 illustrates an example of processing of the radio communication system according to Example 2. This processing is an example of processing performed by the radio communication system 1 when the wireless area 100 is operated in the radio communication system 1 as illustrated in FIG. 5. It is assumed that the storage unit 15 of the control apparatus 10 stores in advance the operating state patterns 16 of the plurality of wireless base stations 20 according to the communication traffic amount of the wireless terminals 30 described above. Here, detailed description of processing contents similar to the processing described in FIGS. 3 and 6 will be omitted.

In step S701, for example, when starting the operation of the wireless area 100, the acquisition unit 13 acquires the communication traffic amount of the wireless terminals 30 in the wireless area 100. For example, the acquisition unit 13 acquires the communication traffic amount of the wireless terminal 30 connected to its own station (wireless base station 20) from each wireless base station 20, and calculates the communication traffic amount of the wireless terminal 30 in the wireless area 100 by summing the acquired communication traffic amounts.

In step S702, the control unit 14 sets the operating state of the plurality of wireless base stations 20-1, 20-2, . . . according to the communication traffic amount of the wireless terminals 30 acquired by the acquisition unit 13 on the basis of the operating state pattern 16 stored in advance in the storage unit 15.

In step S703, the control apparatus 10 determines whether to end the operation of the wireless area 100. When the operation of the wireless area 100 is not ended, the control apparatus 10 shifts the process to step S704. On the other hand, when ending the operation of the wireless area 100, the control apparatus 10 ends the processing of FIG. 7.

When the process proceeds to step S704, the acquisition unit 13 acquires the communication traffic amount of the wireless terminals 30 in the wireless area 100.

In step S705, the control unit 14 determines whether it is necessary to control the operating state of the plurality of wireless base stations 20. For example, when the communication traffic amount of the wireless terminals 30 in the wireless area 100 is within a preset range in which control of the operating state is unnecessary, the control unit 14 determines that control of the operating state is unnecessary. On the other hand, when the communication traffic amount of the wireless terminals 30 in the wireless area 100 is not within a preset range in which control of the operating state is unnecessary, the control unit 14 determines that control of the operating state is necessary. When it is necessary to control the operating state, the control unit 14 shifts the process to step S706. On the other hand, when it is not necessary to control the operating state, the control unit 14 returns the process to step S703.

After the processing is shifted to step S706, the control unit 14 updates the operating state of the plurality of wireless base stations 20-1, 20-2, . . . according to the communication traffic amount of the wireless terminals 30 acquired by the acquisition unit 13 on the basis of the operating state pattern 16 stored in the storage unit 15. After executing the processing of step S706, the control unit 14 returns the process to step S703.

As a result of processing of FIG. 7, the control apparatus 10 dynamically controls the operating state of the plurality of wireless base stations 20-1, 20-2, . . . according to the communication traffic amount of the wireless terminals 30 in the wireless area 100.

As described above, according to the present embodiment, the control apparatus 10 dynamically controls the operating state of the plurality of wireless base stations 20-1, 20-2, . . . according to the state (the number, the communication traffic amount, or the like) of the wireless terminals 30 in the wireless area 100. Therefore, according to the embodiment of the present embodiment, it is possible to suppress degradation of communication quality due to radio interference or the like, or occurrence of extra operating power consumption or the like of a wireless base station when the number of the wireless terminals 30 in the wireless area 100 is smaller than expected.

Although the radio communication system 1 according to the present embodiment has been described above, the radio communication system 1 according to the present embodiment can be variously modified and applied.

For example, in each of the above embodiments, it has been described that the control apparatus 10 controls the operating state of the plurality of wireless base stations 20, but the control apparatus 10 may achieve a similar effect by various means such as power on/off or sleep/return of the plurality of wireless base stations 20. For example, the control apparatus 10 may turn on/off the transmission of the radio wave of each wireless base station 20 while operating the plurality of wireless base stations 20.

In each of the above embodiments, a single radio communication scheme has been assumed and described, but the present embodiment can also be applied to a radio communication system 1 in which wireless base stations 20 of different radio communication schemes are arranged in combination.

Furthermore, the function of the control apparatus 10 may be included in any wireless base station 20 among the plurality of wireless base stations 20.

### <Hardware Configuration Example>

### (Hardware Configuration of Control Apparatus, Wireless Base Station, and Calculation Device)

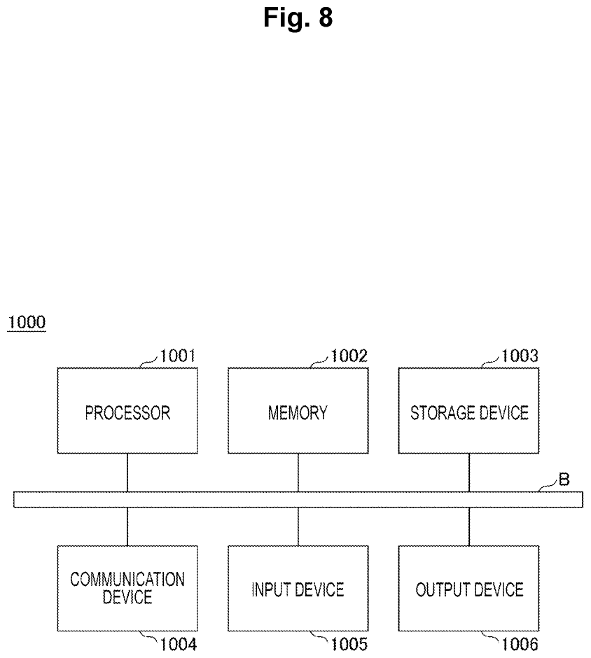

The control apparatus 10, the wireless base station 20, and the calculation device 500 according to the present embodiment have, for example, a hardware configuration of a computer 1000 as illustrated in FIG. 8.

FIG. 8 is a diagram illustrating an example of a hardware configuration of the computer 1000 according to the present embodiment. In the example of FIG. 8, the computer 1000 includes a processor 1001, a memory 1002, a storage device 1003, a communication device 1004, an input device 1005, an output device 1006, a bus B, and the like.

The processor 1001 is, for example, an arithmetic device such as a central processing unit (CPU) that implements various functions by executing a predetermined program stored in a storage medium (recording medium). The memory 1002 is a storage medium (recording medium) readable by the computer 1000 and includes, for example, a random access memory (RAM), a read only memory (ROM), and the like. The storage device 1003 is a computer-readable storage medium (recording medium) and can include, for example, a hard disk drive (HDD), a solid state drive (SSD), various optical disks, and a magneto-optical disk.

The communication device 1004 includes one or more pieces of hardware (communication devices) for communicating with other devices via a wireless or wired network. For example, the communication device 1004 includes a radio communication device for the radio communication unit 21 to perform radio communication, a communication device for the communication units 11, 25, 501, and the like to connect each device to the communication network 2, and the like.

The input device 1005 is an input device (e.g., a keyboard, a mouse, a microphone, a switch, a button, or a sensor) that receives an input from the outside. The output device 1006 is an output device (e.g., a display, a speaker, or an LED lamp) that performs output to the outside. The input device 1005 and the output device 1006 may be integrated (e.g., an input/output device such as a touch panel display).

The bus B is commonly connected to the above-described components and transmits, for example, an address signal, a data signal, various control signals, and the like. The processor 1001 is not limited to a CPU, and may be, for example, a digital signal processor (DSP), a programmable logic device (PLD), or a field programmable gate array (FPGA).

### Supplementary Note

The control apparatus 10, the wireless base station 20, the calculation device 500, and the like in the present embodiment are not necessarily configured by dedicated devices, but may be implemented by general-purpose computers. In that case, a program for implementing this function may be recorded in a computer-readable recording medium, and the program recorded in the recording medium may be read and executed by a computer system to implement this function. Note that the “computer system” mentioned herein includes an OS and hardware such as a peripheral device.

In addition, the “computer-readable recording medium” includes various storage media such as a portable medium such as a flexible disk, a magneto-optical disk, a ROM, and a CD-ROM, as well as a hard disk built into a computer system. Furthermore, the “computer-readable recording medium” may include a medium that dynamically holds a program for a short period of time, such as a communication line in a case where the program is transmitted via a network such as the Internet or a communication line such as a telephone line, and a medium that holds a program for a certain period of time, such as a volatile memory inside a computer system serving as a server or a client in that case.

In addition, the program may be provided for implementing part of the above-described functions, may be capable of implementing the above-described functions in combination with a program already recorded in a computer system, or may be implemented by using hardware such as a programmable logic device (PLD) or a field programmable gate array (FPGA).

### Effects of Embodiment

According to the present embodiment, it is possible to suppress degradation of communication quality due to radio interference or the like, or occurrence of extra operating power consumption or the like of a wireless base station when the number of the wireless terminals in the wireless area is smaller than expected.

### Summary of Embodiment

The present specification discloses at least the radio communication method and the radio communication system in the following clauses.

### Clause 1

A radio communication system including a plurality of wireless base stations installed in a wireless area, and further including:
a calculation unit configured to calculate an operating state pattern of the plurality of wireless base stations according to a state of a wireless terminal in the wireless area;
an acquisition unit configured to acquire a state of the wireless terminal in the wireless area; and
a control unit configured to control, on the basis of the operating state pattern, an operating state of the plurality of wireless base stations according to the state of the wireless terminal acquired by the acquisition unit.

### Clause 2

The radio communication system according to clause 1,
in which the state of the wireless terminal includes the number of the wireless terminals in the wireless area, and
the operating state pattern includes information for specifying whether to operate each of the plurality of wireless base stations, according to the number of the wireless terminals in the wireless area.

### Clause 3

The radio communication system according to clause 1,
in which the state of the wireless terminal includes a communication traffic amount of the wireless terminal in the wireless area, and
the operating state pattern includes information for specifying whether to operate each of the plurality of wireless base stations, according to the communication traffic amount of the wireless terminal in the wireless area.

### Clause 4

The radio communication system according to any one of clauses 1 to 3, in which the calculation unit calculates the operating state pattern that corresponds to the state of the wireless terminal in the wireless area, can accommodate the wireless terminal, and minimizes the number of the wireless base stations to be operated.

### Clause 5

The radio communication system according to any one of clauses 1 to 3,
in which the acquisition unit periodically acquires the state of the wireless terminal in the wireless area, and
the control unit dynamically controls the operating state of the plurality of wireless base stations, according to the state of the wireless terminal in the wireless area acquired by the acquisition unit.

### Clause 6

A control apparatus that controls a plurality of wireless base stations installed in a wireless area, the control apparatus including:
a calculation unit configured to calculate an operating state pattern of the plurality of wireless base stations, according to a state of a wireless terminal in the wireless area;
an acquisition unit configured to acquire a state of the wireless terminal in the wireless area; and
a control unit configured to control, on the basis of the operating state pattern, an operating state of the plurality of wireless base stations according to the state of the wireless terminal acquired by the acquisition unit.

### Clause 7

A control method of a plurality of wireless base stations installed in a wireless area,
in which a computer executes:
calculation processing of calculating an operating state pattern of the plurality of wireless base stations, according to a state of a wireless terminal in the wireless area;
acquisition processing of acquiring a state of the wireless terminal in the wireless area; and
control processing of controlling, based on the operating state pattern, an operating state of the plurality of wireless base stations according to the state of the wireless terminal acquired by the acquisition processing.

### Clause 8

A program that causes a computer to execute the control method according to clause 7.

Although the present embodiment has been described, the present invention is not limited to such a specific embodiment, and various modifications and changes can be made within the scope of the gist of the present invention described in the claims.

### REFERENCE SIGNS LIST

1 Radio communication system
10 Control apparatus
12 Calculation unit
13 Acquisition unit
14 Control unit
16 Operating state pattern
20, 20-1, 20-2 Wireless base station
30, 30-1, 30-2 Wireless terminal
100 Wireless area
1000 Computer

1. A radio communication system comprising a plurality of wireless base stations installed in a wireless area, and further comprising:
a processor; and
a memory that includes instructions, which when executed, cause the processor to execute:
calculating an operating state pattern of the plurality of wireless base stations according to a state of a wireless terminal in the wireless area;
acquiring a state of the wireless terminal in the wireless area; and
controlling, based on the operating state pattern, an operating state of the plurality of wireless base stations according to the state of the wireless terminal acquired at the acquiring.

2. The radio communication system according to claim 1,
wherein the state of the wireless terminal includes the number of the wireless terminals in the wireless area, and
the operating state pattern includes information for specifying whether to operate each of the plurality of wireless base stations, according to the number of the wireless terminals in the wireless area.

3. The radio communication system according to claim 1,
wherein the state of the wireless terminal includes a communication traffic amount of the wireless terminal in the wireless area, and
the operating state pattern includes information for specifying whether to operate each of the plurality of wireless base stations, according to the communication traffic amount of the wireless terminal in the wireless area.

4. The radio communication system according to claim 1, wherein the calculating includes calculating the operating state pattern that corresponds to the state of the wireless terminal in the wireless area, can accommodate the wireless terminal, and minimizes the number of the wireless base stations to be operated.

5. The radio communication system according to claim 1,
wherein the acquiring includes periodically acquiring the state of the wireless terminal in the wireless area, and
the controlling includes dynamically controlling the operating state of the plurality of wireless base stations, according to the state of the wireless terminal in the wireless area acquired at the acquiring.

6. A control apparatus that controls a plurality of wireless base stations installed in a wireless area, the control apparatus comprising:
a processor; and
a memory that includes instructions, which when executed, cause the processor to execute:
calculating an operating state pattern of the plurality of wireless base stations, according to a state of a wireless terminal in the wireless area;
acquiring the state of the wireless terminal in the wireless area; and
controlling, based on the operating state pattern, an operating state of the plurality of wireless base stations according to the state of the wireless terminal acquired at the acquiring.

7. A control method of a plurality of wireless base stations installed in a wireless area,
wherein a computer executes:
calculating an operating state pattern of the plurality of wireless base stations, according to a state of a wireless terminal in the wireless area;
acquiring a state of the wireless terminal in the wireless area; and
controlling, based on the operating state pattern, an operating state of the plurality of wireless base stations according to the state of the wireless terminal acquired at the acquiring.

8. A non-transitory computer-readable recording medium having computer-readable instructions stored thereon, which when executed, cause a computer including a memory and a processor to execute a process performed in a radio communication system including a plurality of wireless base stations installed in a wireless area, the process comprising:
calculating an operating state pattern of the plurality of wireless base stations, according to a state of a wireless terminal in the wireless area;
acquiring a state of the wireless terminal in the wireless area; and
controlling, based on the operating state pattern, an operating state of the plurality of wireless base stations according to the state of the wireless terminal acquired at the acquiring.
